(19) United States
(12) Patent Application Publication
(10) Pub. No.: US 2019/0244254 A1
(43) Pub. Date: Aug. 8, 2019

(54) Sequential Remarketing

(71) Applicant: Google Inc., Mountain View, CA (US)

(72) Inventors: Justin Lewis, Marina del Rey, CA (US); Ruxandra Georgiana Paun, Santa Monica, CA (US)

(21) Appl. No.: 14/306,032

(22) Filed: Jun. 16, 2014

(51) Int. Cl. G06Q 30/02

(52) U.S. Cl. CPC G06Q 30/0272

(57) ABSTRACT

Methods, systems, and apparatus include computer programs encoded on a computer-readable storage medium for sequential presentation of content. A method includes: receiving a first request for content; identifying a campaign including a first content item for presenting in response to the first request; determining a first time associated with the first request; determining an expiration time associated with a sequential presentation of content items based on presentation of the first content item; receiving a second request for content; after receiving the second request for content, determining whether the expiration time has passed, and when not, determining an amount of time that has elapsed since the first time; and determining a second, different content item to deliver in response to the second request based at least in part on the amount of elapsed time.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Slots can be allocated to content sponsors through a reservation system or an auction. For example, content sponsors can provide bids specifying amounts that the sponsors are respectively willing to pay for presentation of their content. In turn, a reservation can be made or an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a method for sequential presentation of content. The method comprises: receiving a first request for content; identifying a campaign including a first content item for presenting in response to the first request; determining a first time associated with the first request; determining an expiration time associated with a sequential presentation of content items based on presentation of the first content item; receiving a second request for content; after receiving the second request for content, determining whether the expiration time has passed, and when not, determining an amount of time that has elapsed since the first time; and determining a second, different content item to deliver in response to the second request based at least in part on the amount of elapsed time.

In general, another aspect of the subject matter described in this specification can be implemented in computer program products. A computer program product is tangibly embodied in a computer-readable storage device and comprises instructions. The instructions, when executed by a processor, cause the processor to: receive a first request for content; identify a campaign including a first content item for presenting in response to the first request; determine a first time associated with the first request; determine an expiration time associated with a sequential presentation of content items based on presentation of the first content item; receive a second request for content; after receiving the second request for content, determine whether the expiration time has passed, and when not, determining an amount of time that has elapsed since the first time; and determine a second, different content item to deliver in response to the second request based at least in part on the amount of elapsed time.

In general, another aspect of the subject matter described in this specification can be implemented in systems. A system includes one or more processors and one or more memory elements including instructions. The instructions, when executed, cause the one or more processors to: receive a first request for content; identify a campaign including a first content item for presenting in response to the first request; determine a first time associated with the first request; determine an expiration time associated with a sequential presentation of content items based on presentation of the first content item; receive a second request for content; after receiving the second request for content, determine whether the expiration time has passed, and when not, determining an amount of time that has elapsed since the first time; and determine a second, different content item to deliver in response to the second request based at least in part on the amount of elapsed time.

These and other implementations can each optionally include one or more of the following features. The second, different content item can be a second content item in a sequence in the campaign. The second, different content item can be from the campaign. When the determined elapsed time is greater than a predetermined threshold, the first content item can be re-presented responsive to the second request. When the expiration time has passed, a new first content item can be determined for delivery in response to the second request. Determining the second, different content item can include determining eligible content items from inventory, determining a second content item from the campaign, ranking the eligible content items from inventory and the second content item from the campaign, and selecting the second, different content item based at least in part on the ranking A score for the second, different content item from the campaign can be boosted based at least in part on an amount of time since the first content item was presented. Determining a second, different content item can include adding a countdown timer to the second, different content item to show an amount of time until the expiration time. A reward can be provided for generating the second request prior to the occurrence of the expiration time. The expiration time can be determined based at least in part on input from a content sponsor associated with the campaign. The expiration time can be adjusted based on a geographic location of the first or second request. The expiration time can depend on a platform on which the first content item was served or platform on which the second request occurred. The first content item can be an application and the expiration time can be based on loading the application.

Particular implementations may realize none, one or more of the following advantages. One or more tools can be provided to a content sponsor for encouraging users to become repeat visitors to one or more resources associated with the content sponsor. A content sponsor can generate a group of highly retained users. A user can be presented content items that are familiar to the user when the content items relate to the user's recent interaction with a site, service, application or other resource.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for providing content to a user.

FIG. 2 illustrates an example campaign management user interface.

FIGS. 3 and 4 are block diagrams of an example system for providing content to a user.

FIG. 5 is a flowchart of an example process for sequential presentation of content.

FIG. 6 is a flowchart of an example process for determining a second content item to deliver in response to a second request for content.

FIG. 7 is a block diagram of computing devices that may be used to implement the systems and methods described in this document, as either a client or as a server or plurality of servers.

Like reference numbers and designations in the various drawings indicate like elements.

### DETAILED DESCRIPTION

A sequential presentation of content items can be configured for a content campaign. For example, a first content item in a sequence can be provided to a user device in response to a first request for content. Thereafter, a second request for content can be received from a same user device/user. Based on one or more of an elapsed time since the providing of the first content item and an expiration time associated with the sequence, a second content item in the sequence can be provided in response to the second request for content.

For situations in which the systems discussed here collect information about users, or may make use of information about users, the users may be provided with an opportunity to control whether programs or features collect user information (e.g., information about a user's social network, social actions or activities, profession, demographics, a user's preferences, or a user's current location), or to control whether and/or how to receive content from a content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information about the user is collected and used by a content server.

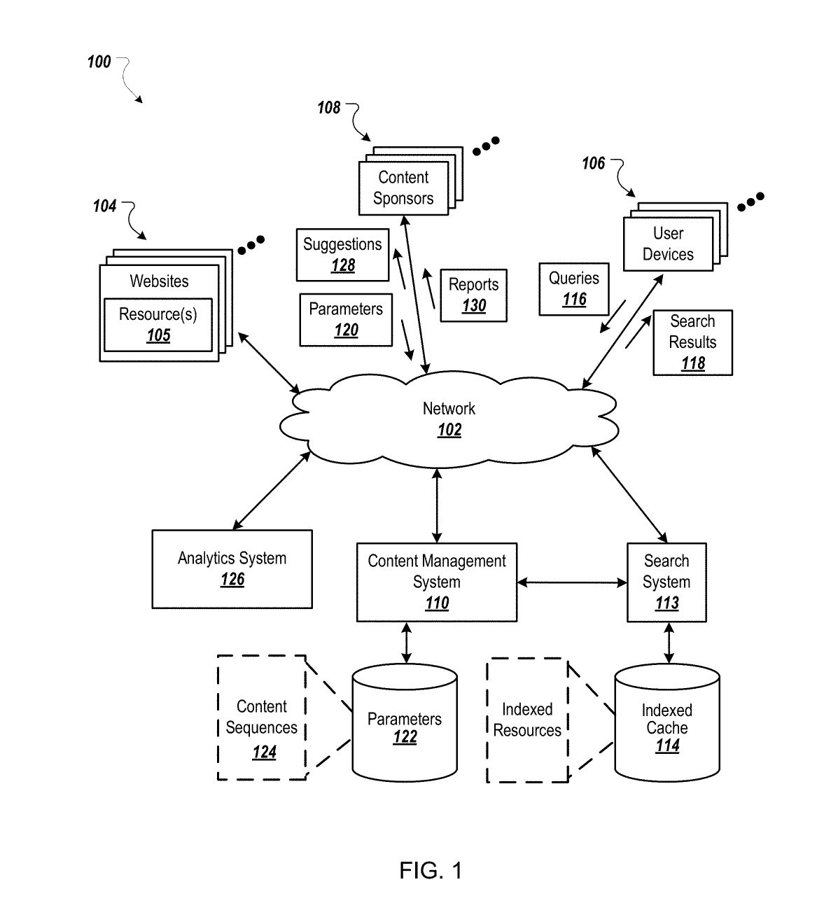

FIG. 1 is a block diagram of an example environment 100 for providing content to a user device/user. The example environment 100 includes a network 102, such as a local area network (LAN), a wide area network (WAN), the Internet, or a combination thereof. The network 102 connects websites 104, user devices 106, content sponsors 108, publishers, a content management system 110, and a search system 113. The example environment 100 may include many thousands of websites 104, user devices 106, and content sponsors 108. The content management system 110 may be used for selecting and providing content in response to requests for content. The content sponsors 108 can be, for example, advertisers. Other types of content sponsors are possible.

A website 104 includes one or more resources 105 associated with a domain name and hosted by one or more servers. An example website 104 is a collection of web pages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources 105 include HTML pages, word processing documents, portable document format (PDF) documents, images, video, applications, and news feed sources, to name only a few. The resources 105 can include content, such as words, phrases, videos, images and sounds, that may include embedded information (such as meta-information hyperlinks) and/or embedded instructions (such as scripts). A content sponsor 108 can act as a content publisher and can be associated with a website 104, and with one or more resources 105 (e.g., web pages, applications, other resources).

A user device 106 is an electronic device that is under control of a user and is capable of requesting and receiving resources 105 over the network 102. Example user devices 106 include personal computers, tablet computers, mobile communication devices (e.g., smartphones), televisions, set top boxes, personal digital assistants and other devices that can send and receive data over the network 102. A user device 106 typically includes one or more user applications, such as a web browser, to facilitate the sending and receiving of data over the network 102. The web browser can interact with various types of web applications, such as a game, a map application, or an e-mail application, to name a few examples.

A user device 106 can request resources 105 from a website 104. In turn, data representing the resource 105 can be provided to the user device 106 for presentation by the user device 106. User devices 106 can also submit search queries 116 to the search system 113 over the network 102. In response to a search query 116, the search system 113 can, for example, access an indexed cache 114 to identify resources 105 that are relevant to the search query 116. The search system 113 identifies the resources 105 in the form of search results 118 and returns the search results 118 to the user devices 106 in search results pages. A search result 118 is data generated by the search system 113 that identifies a resource 105 that is responsive to a particular search query 116, and can include a link to the resource 105. An example search result 118 can include a web page title, a snippet of text or a portion of an image extracted from the web page, and the URL (Unified Resource Location) of the web page.

The data representing the resource 105 or the search results 118 can also include data specifying a portion of the resource 105 or search results 118 or a portion of a user display (e.g., a presentation location of a pop-up window or in a slot of a web page) in which other content (e.g., advertisements) can be presented. These specified portions of the resource or user display are referred to as slots or impressions. An example slot is an advertisement slot.

When a resource 105 or search results 118 are requested by a user device 106, the content management system 110 may receive a request for content to be provided with the resource 105 or search results 118. The request for content can include characteristics of one or more slots or impressions that are defined for the requested resource 105 or search results 118. For example, a reference (e.g., URL) to the resource 105 or search results 118 for which the slot is defined, a size of the slot, and/or media types that are available for presentation in the slot can be provided to the content management system 110. Similarly, keywords associated with a requested resource 105 or a search query 116 for which search results 118 are requested can also be provided to the content management system 110 to facilitate identification of content that is relevant to the resource 105 or search query 116. An identifier (e.g., cookie) associated with the user device 106 can be received with the request for content.

Based, for example, on data included in the request for content, the content management system 110 can select content items that are eligible to be provided in response to the request. One or more selected content items can be provided to the user device 106 in association with providing an associated resource 105 or search results 118. The provided content item(s) can be presented on the user device 106, in one or more respective slots.

In some implementations, the content management system 110 can select content items based at least in part on results of an auction. For example, content sponsors 108 can provide bids specifying amounts that the content sponsors 108 are respectively willing to pay for presentation of their content items. In turn, an auction can be performed and the slots can be allocated to content sponsors 108 according, among other things, to their bids and/or the relevance of a content item to content presented on a page hosting the slot or a request that is received for the content item. For example, when a slot is being allocated in an auction, the slot can be allocated to the content sponsor 108 that provided the highest bid or a highest auction score (e.g., a score that is computed as a function of a bid and/or a quality measure). When multiple slots are allocated in a single auction, the slots can be allocated to a set of bidders that provided the highest bids or have the highest auction scores.

A content sponsor 108 or content sponsor can create a content campaign associated with one or more content items using tools provided by the content management system 110. For example, the content management system 110 can provide one or more account management user interfaces for creating and managing content campaigns. The account management user interfaces can be made available to the content sponsor 108, for example, either through an online interface provided by the content management system 110 or as an account management software application installed and executed locally at a content sponsor's client device.

A content sponsor 108 can, using the account management user interfaces, provide campaign parameters 120 which define a content campaign. The content campaign can be created and activated for the content sponsor 108 according to the parameters 120 specified by the content sponsor 108. The campaign parameters 120 can be stored in a parameters data store 122. Campaign parameters 120 can include, for example, a campaign name, a preferred content network for placing content, a budget for the campaign, start and end dates for the campaign, a schedule for content placements, content (e.g., creatives), bids, and selection criteria. Selection criteria can include, for example, a language, one or more geographical locations or websites, and one or more selection terms. As described in more detail below, the parameters 120 can include information that defines a content sequence.

The content management system 110 can, for example, provide one or more tools for a content sponsor 108 to build and engage with a group of users who regularly interact with content items and/or resources 105 associated with the content sponsor 108. For example, the content management system 110 can provide tools which allow a content sponsor 108 to create a definition of a content sequence which can be used for a sequential presentation of content from the campaign to a given user device 106/user. A content sequence can be configured, for example, for one or more goals of encouraging interactions or engagements with presented content items, visits to a web site 104 of the content sponsor 108 (e.g., a domain or collection of domains), or performing conversions associated with the campaign. A content sequence can be used to encourage users to make repeat visits to a site, service, application or other resource associated with the content sponsor 108. A content sponsor 108 may decide on such a goal, for example, because users who repeatedly visit or use content sponsor resources may tend to value the resources more than users who do not frequently use or visit the resources. Value, in this context, can represent relevance to the user. The more relevant the content, the more likely the user may be to interact with the content, hence driving revenue for entities in the content publication stream.

The content sponsor 108 can use a campaign management user interface provided by the content management system 110 to configure a content sequence. Information that defines the content sequence can be stored in the parameters datastore 122 (e.g., as content sequence definitions 124). As another example, an analytics system 126 (or the content management system 110) can automatically determine a sequence of content items (e.g., based on analysis of historical interactions and performance of content items associated with the content sponsor 108) and provide one or more suggestions 128 for a content sequence or parameters associated therewith to the content sponsor 108. The content sponsor 108 can approve one or more of the suggestions 128 and a content sequence can be defined for the content sponsor 108 and associated with the campaign.

After a content sequence has been defined, the content management system 110 can receive, from a user device 106, a first request for content and can identify a campaign associated with a content sponsor 108 that includes a first content item that is associated with the content sequence. The content management system 110 can select the first content item in response to the first request for content, for presentation on the user device 106. The content management system 110 can determine an expiration time (i.e., after a time associated with the first presentation) associated with a sequential presentation of content items from the content sequence, such as based on the time of the first request for content or on a time that the user of the user device 106 last interacted with a resource 105 associated with content in the sequence or otherwise with the content sponsor 108. A second request for content can be received before the expiration time has passed. The content management system 110 can select a second, different content item to deliver in response to the second request for content, such as the second content item in the content sequence. Various other approaches for timing and other options for sequential presentation of content are discussed below.

The content management system 110 can provide one or more report(s) 130 to a content sponsor 108. The report(s) 130 can include performance information for content items associated with the content sponsor 108. One or more of the report(s) 130 can include performance information associated with content sequences. For example, a report can show a comparison between two content sequences in a campaign, such as statistics for how often users view content items in the content sequences at different positions in the sequence (e.g., how often users are presented a next content item in a sequence before an expiration time is reached). Other reporting metrics are possible. The report(s) 310 can include aggregated (or otherwise treated) data about user impression and other user-related information, such that no identifying information can be determined for a particular user.

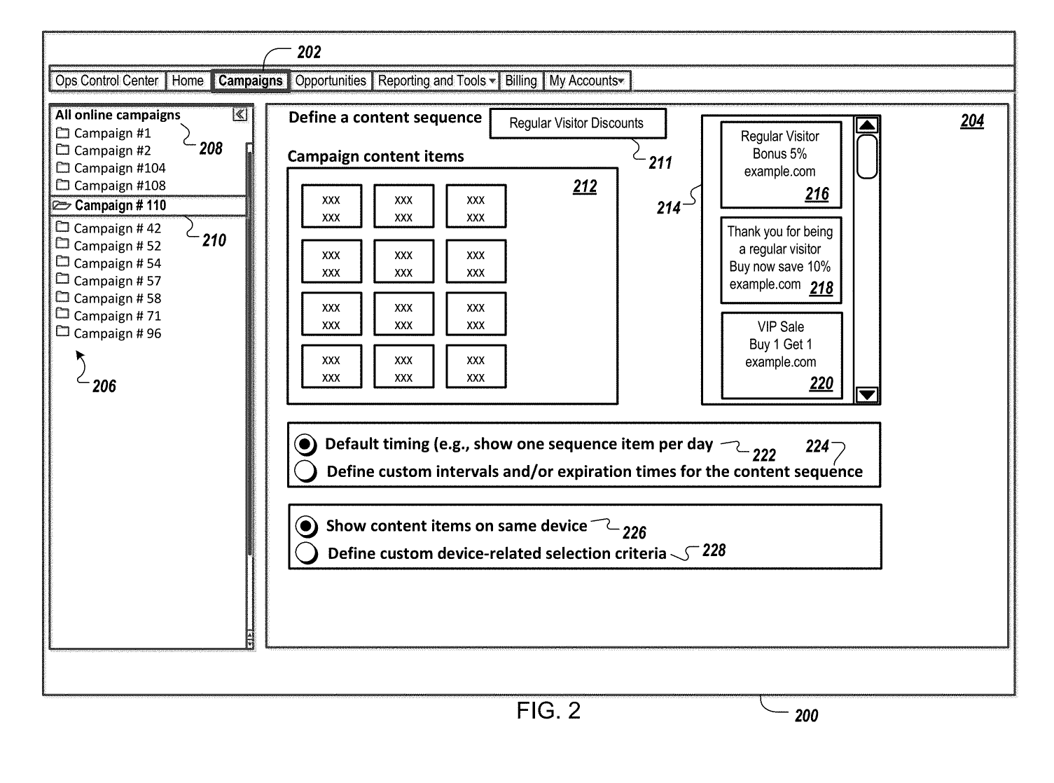

FIG. 2 illustrates an example campaign management user interface 200. The user interface 200 can be included, for example, in one or more user interfaces that a user, such as a content sponsor, can use to configure a campaign. The content sponsor can select a tab 202 to display a campaign configuration area 204. The content sponsor can view a list 206 of campaigns by selecting a control 208. The content sponsor can edit an existing campaign in the campaign configuration area 204 by selecting the name of an existing campaign (e.g., a name 210) in the campaign list 206.

The content sponsor can use the campaign configuration area 204 to define a content sequence for the campaign. For example, a name can be configured for the content sequence using a name control 211. As another example, the content sponsor can select campaign content items from a content item list 212 for adding to a content sequence list 214. For example, the content sponsor can “drag and drop” a content item from the content item list 212 to the content sequence list 214. Other user interface interactions are possible. The content sequence list 214 includes content items 216, 218, and 220. The content sponsor can arrange the content items included in the content sequence list 214 in a desired order. In some implementations, a same content item can be included multiple times within a same sequence. Multiple content sequences can be defined for a campaign. In some implementations, a sequence can be configured to include plural branches enabling a content sponsor to customize presentation for content in the sequence based on one or several different criteria during execution of the sequence. For example, one branch can be dependent on an amount of time since the last interaction (e.g., left branch if time t<X or right branch if time t>X). Other example branches are discussed below.

The content sponsor can select, for example, a default-timing control 222 to configure default timing for the content sequence (e.g., showing one content item from the sequence, per day). Other default timing configurations are possible. As another example, the content sponsor can select a custom-timing control 224 to define custom timing for the campaign (e.g., using another user interface (not shown)). Custom timing can include, for example, one or more custom expiration times, branch conditions and/or wait times for one or more content items included in the sequence. Expiration and wait times are discussed in more detail below.

The content sponsor can select a same-device control 226 (or same application control (not shown) to specify that content items in the content sequence are to be shown on a same device (or in association with a same application) for a user. For example, content items in the content sequence can be presented related to a user's use of an application on a first device. In response to selection of the same-device control 226, content items in the content sequence can be presented to a user on the device (i.e., the first device) on which the application is installed. As another example and as described in more detail below, content items in a sequence can be presented in response to a user's interaction with a site associated with the content sponsor. In response to selection of the same-device control 226, content items in the content sequence can be presented to a user on the device on which the user uses to visit the site.

The content sponsor can select a custom device criteria control 228 to configure custom device-related selection criteria (e.g., using another user interface (not shown)). For example, the content sponsor can specify that content items in the content sequence are to be presented on a device associated with the user other than a device that the user has used to perform some action (e.g., installing an application, visiting a site associated with the content sponsor). Other user interface options are possible. For example, the user interface 200 can include one or more controls for specifying bid(s) for the presentation of content item(s) included in the content sequence.

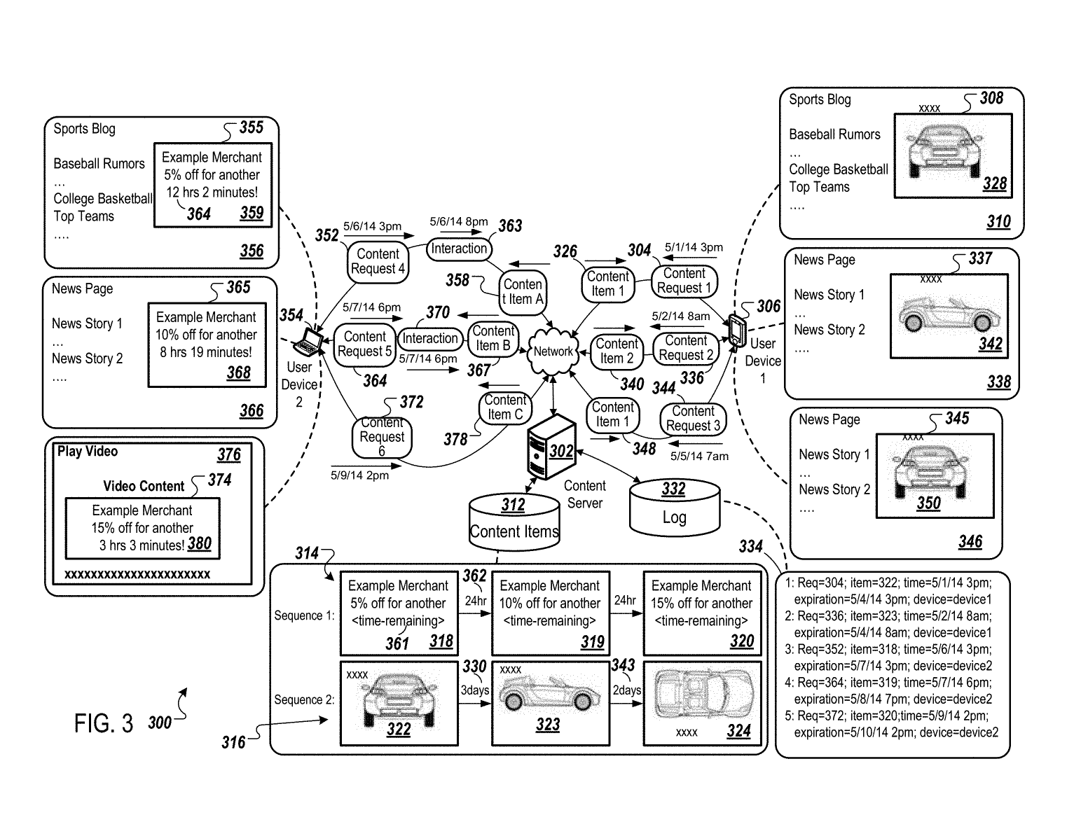

FIG. 3 is a block diagram of an example system 300 for providing content to a user. A content server 302 can receive a first content request 304 from a user device 306 for a content slot 308 included in a resource 310 that is presented on the user device 306. The content server 302 can conduct an auction for the content slot 308 and can select a content item for the content slot 308 based on the result of the auction. For example, the content slot 308 can be allocated to a content item that receives a highest auction score (e.g., a score that is computed as a function of a bid and/or a quality measure). The quality measure can indicate, for example, a relevance of a content item to content presented on the resource 310 and/or to other aspects of the content request 304.

Content items that participate in the auction can include content items that are part of a defined sequence of content items. For example, a sequence of content items can be defined by a content sponsor, as described above. For instance, a content items repository 312 can include a first sequence 314 and a second sequence 316. The first sequence 314 includes content items 318, 319, and 320. The second sequence 316 includes content items 322, 323, and 324.

A campaign associated with the content item 322 can, for example, win the auction conducted for the content slot 308. The content server 302 can provide the content item 322 to the user device 306 (e.g., as illustrated by a provided content item 326), for presentation in the content slot 308 (e.g., as illustrated by a presented content item 328) as a first item in the sequence associated with the campaign.

The content server 302 can determine that the provided content item 322 is part of the second sequence 316. In response to determining that the provided content item 322 is part of the second sequence 316, the content server 302 can determine an expiration time associated with the first content request 304 (e.g., an expiration time associated with the providing of the first content item in the second sequence 316). For example, the expiration time can be associated with a sequential presentation of content items from the second sequence 316, or more specifically, an expiration time by which the second (or other) content item in the second sequence 316 (e.g., the content item 323) is to be presented to the user of the user device 306.

The expiration time associated with the first content request 304 can be determined, for example and at least in part, by identifying an expiration interval associated with the content item 322. The expiration interval can be identified, for example, in information used to define the second sequence 316. For example, an expiration interval 330 of three days can be identified. The expiration interval 330 (and other expiration intervals associated with the second sequence 316) can be provided, for example, by a content sponsor. In some implementations, the content sponsor can specify a custom expiration interval for each content item in the second sequence 316. For example, the second sequence 316 is associated with expiration intervals of different lengths (e.g., 3 days, 2 days). As another example, the content sponsor can specify a same expiration interval for each content item in a sequence (e.g., multiple, same twenty-four expiration intervals are configured for the first sequence 314, as shown).

The content server 302 can determine the expiration time associated with the first content request 304, for example, by adding the determined expiration interval to a request time associated with the first content request 304. For example, the content server 302 can log a request time (e.g., 5/1/14 3 pm) associated with the first content request 304 and a determined expiration time (e.g., 5/4/14 3 pm) associated with the first content request 304 in a logs datastore 332, as illustrated by a first entry in example log data 334. Other information can be stored in the first entry, such as a device identifier and an identifier of the content item provided in response to the first content request 304 (e.g., the content item 322). In some implementations, the specific expiration time is not pre-determined (though the expiration interval is known/stored). That is, in some implementations, an amount of time that has passed since a last/first/previous presentation of content in a sequence can be determined at a time of a subsequently received request. Depending on an amount of elapsed time, a determination can be made to show a next or another content item in the sequence or other content item. As will be discussed in greater detail below, a conventional auction can be conducted at a time the subsequent request is received. Relevant content items can be selected for inclusion in the auction. A campaign that is active (e.g., has previously presented a content item in a sequence and has time left prior to the expiration interval), can be ranked higher so as to increase a likelihood that the campaign will be selected as a winner of the auction. Ranking and relevance are discussed in more detail below.

The content server 302 can receive a second content request 336 from the user device 306 for a content slot 337 included in a resource 338 that is presented on the user device 306. The content server 302 can conduct an auction for the content slot 337 and can select a content item for the content slot 337 based on the result of the auction. The content server 302 can determine that the campaign (e.g., the campaign associated with content item 323) is an eligible content item for the second content request 336.

The content server 302 can adjust an auction score for the content item 323. For example, the content server 302 can determine that the content item 323 is a second content item in the second sequence 316 and that the first content request 304 was fulfilled using the content item 322 (e.g., the first content item in the second sequence 316). The content server 302 can evaluate the conditions associated with the sequence (e.g., determine whether the expiration time associated with the first content request 304 has passed). For example, the content server 302 can compare the expiration time (e.g., 5/4/14 3 pm) to a time (e.g., 5/2/14 8 am) associated with the second content request 336. When the expiration time associated with the first content request 304 has not passed (e.g., as in this example), the content server 302 can determine an amount of time that has elapsed since the first content request 304 (e.g., seventeen hours).

In some implementations, the content server 302 can adjust an auction score associated with the content item 323 based on the determined amount of elapsed time. For instance and in general, an auction score for a content item that is next to be presented in a sequence of content items can be adjusted so that the increase in the auction score corresponds to an urgency of delivering the content item before an expiration time associated with the previous content item in the sequence. For example, a score adjustment for the content item 323 can be based on a difference between the elapsed time since the first content request 304 and the expiration interval associated with the first content request 304, with the smaller the difference, the greater the score adjustment. For instance, in this example, a difference between the amount of elapsed time (e.g., seventeen hours) and the expiration interval associated with the first content request 304 (e.g., three days) is fifty five hours, and a corresponding score adjustment may be an increase of ten percent. As another example, when a difference between an amount of elapsed time and an expiration interval is a lesser amount of time than fifty five hours (e.g., five hours), a corresponding score adjustment can be, for example, an increase of forty percent.

In this example, suppose that the content item 323 wins the auction for the content slot 337 (e.g., based on an adjusted auction score for the content item 323). The content server 302 can provide the content item 323 to the user device 306 (e.g., as illustrated by a provided content item 340), for presentation in the content slot 337 (e.g., as illustrated by a presented content item 342). As illustrated in a second entry in the example log data 334, the content server 302 can log a request time (e.g., 5/2/14 8 am) associated with the second content request 336, a determined expiration time (e.g., 5/4/14 8 am) associated with the second content request 336 (e.g., determined based on an expiration interval 343 of two days), a device identifier, and an identifier of the content item provided in response to the second content request 336 (e.g., the content item 323).

The content server 302 can receive a request for content after an expiration time associated with a previous content request has passed. For example, an expiration time associated with a presented content item included in a sequence may have passed. In such an example, the content server 302 can take some action in response to the request for content other than selecting the next content item in the sequence. For example, the content server 302 can re-select the previously presented content item (e.g., for re-presentation) assuming there are no other restrictions on its re-presentation (and that it is still in inventory). As another example, the content server 302 can select some other content item (e.g., a content item that is a first (or otherwise positioned) content item in another sequence, or some other content item).

For example, the content server 302 can receive a third content request 344 from the user device 306 for a content slot 345 included in a resource 346. The content server 302 can conduct an auction for the content slot 345. The content server 302 can determine that an expiration time associated with the second content request (e.g., 5/4/14 8 am) has passed, based on a time (e.g., 5/5/14 7 am) associated with the third content request 344. Based on determining that the expiration time associated with the second content request 336 has passed, the content server 302 can determine, for example, that the content item 324 (e.g., the third content item in the second sequence 316) is not an eligible content item for the third content request 344. As another example, the content server 304 can decrease (or not raise) an auction score associated with the content item 324 based on determining that the expiration time associated with the second content request 336 has passed.

Upon determining that the expiration time associated with the second content request 336 has passed, the content server 302 can determine to select the content item 322 in response to the third content request 344. For example, based on determining that the expiration time associated with the second content request 336 has passed, the content server 302 can adjust (e.g., increase, so as to encourage starting another sequence) an auction score associated with the content item 322 and can, when the content item 322 wins the auction for the content slot 345, select the content item 322 for the content slot 345. The content server 302 can provide the content item 322 to the user device 306 (e.g., as illustrated by a provided content item 348), for presentation in the content slot 345 (e.g., as illustrated by a presented content item 350). In general, the content server 302 can select (or boost an auction score for) a first content item in a sequence when a determination has been made that an expiration time associated with the sequence has passed. The first content item in the sequence (e.g., the content item 322) can be re-presented, for example, rather than presenting a next content item in the sequence (e.g., the content item 324).

A content campaign associated with the second sequence 316 may be, for example, a brand campaign. A goal of the campaign may be to promote the brand, e.g., through impressions of the content items 322, 323, and 324. The second sequence 316 may be configured, for example, to promote front, side, and top views of an automobile, in sequence to a user. Content sequences can be used for campaigns other than brand campaigns, such as campaigns that have different goals, such as generating interactions or engagements with presented content items, visits to a web site of the content sponsor, or direct conversions generated from the campaign.

The first sequence 314, for example, can be configured with a goal of having a user make repeated visits to a site (e.g., an examplemerchant.com site). For example, the content server 302 can receive a fourth content request 352 from a user device 354 for a content slot 355 included in a resource 356. The content server 302 can conduct an auction for the content slot 355 and determine that the first campaign (associated with the first sequence 314 and content item 318) is the auction winner. The content server 302 can provide the selected content item 318 to the user device 354 (e.g., as illustrated by a provided content item 358), for presentation in the content slot 355 (e.g., as illustrated by a presented content item 359).

The content server 302 can determine that the provided content item 318 is part of the first sequence 314 and can determine an expiration time associated with the fourth content request 352, such as by identifying an expiration interval 362 (e.g., twenty four hours) associated with the content item 318. The content server 302 can determine an expiration time (e.g., 5/7/14 3 pm) associated with the fourth content request 352, for example, by adding the expiration interval 362 to a request time (e.g., 5/6/14 3 pm) associated with the fourth content request 352. As illustrated in a third entry in the example log data 334, the content server 302 can log the request time, the determined expiration time, a device identifier, and an identifier of the content item provided in response to the fourth content request 352 (e.g., the content item 318).

The expiration time (e.g., 5/7/14 3 pm) associated with the fourth content request 352 can represent, for example, a time by which the user of the user device 354 is to perform some action to advance to a next content item in the first sequence 314. The action can be an action performed, for example, using the user device 354. As another example, the action can be an action performed by the user using another user device (e.g., the user may be logged into a same service associated with the content server 302 while using both the user device 354 and another user device).

The action to perform can include, for example, interacting with the presented content item 359. For example, the user may select the presented content item 359 (or may select an item included in the presented content item 359) to view, for example, a landing page associated with the content sponsor (e.g., an “examplemerchant.com” site). As another example, the action can be that the user has visited the landing page (or another resource) of the content sponsor by means other than selecting the presented content item 359. The content server 302 can received an indication 363 of the interaction with the presented content item 359 (or an indication of some other interaction).

In some implementations, a countdown timer 360 can be included in the presented content item 359 which can be a rolling counter that updates (e.g., every second, every minute), to display an amount of time left until the expiration time. The content item 318 includes, for example, a countdown timer placeholder 361 that can be instantiated to be a dynamic countdown timer when the presented content item 359 is presented. In some implementations, the countdown timer can represent a total amount of time remaining to progress through an entire sequence, rather than just to a next step in the sequence. In some implementations, in association with the countdown timer, a description of a next action that needs to be performed or a link to a next item in the sequence can be provided to enable a user to easily traverse the sequence once initiated.

In response to determining that the user has performed an action, a determination can be made as to whether the action was performed before an expiration time. The expiration time can be, for example, the expiration time associated with the fourth content request 352. As another example, the expiration time can be based on a time that the user has last performed an action, such as viewing a resource (e.g., site, application) associated with the content sponsor. In the example of FIG. 3, the content server 302 can determine that the indication 363 of the interaction with the presented content item 359 occurred before the expiration time associated with the fourth content request 352.

When the user has performed an action before the expiration time, the content server 302 can, during a predetermined time interval, determine to select a next content item (e.g., the content item 319) in the first sequence 314 in response to a request for content. In some implementations, the predetermined time interval begins at the request time of the fourth content request 352 (e.g., 5/6/14 3 pm) and ends at the expiration time (e.g., 5/7/14 3 pm) associated with the fourth content request 352. That is, the next content item in the first sequence can be provided to the user when the user has performed an action after the fourth content request 352 and a next request for content associated with the user is received within the time interval 362 after the content server 302 receives the fourth content request 352. As another example, the predetermined time interval can begin at a time (e.g., 5/6/14 8 pm) that the indication 363 of the interaction with the presented content item 359 is received. The predetermined time interval can have a length, for example, equal to the time interval 362 (e.g., twenty four hours), or some other length.

As an example, suppose the content server 302 receives a fifth content request 364 at 5/7/14 6 pm (e.g., within twenty four hours from the receiving of the indication 363). The fifth content request 364 is for a content slot 365 presented on a resource 366. The content server 302 can determine that the fifth content request 364 is received within the predetermined time interval and can determine to deliver a next content item in the first sequence 314 (e.g., the content item 319). The content server 302 can provide the content item 319 to the user device 354 (e.g., as illustrated by a provided content item 367), for presentation in the content slot 365 (e.g., as illustrated by a presented content item 368).

In general, as long as the user remains “in sequence” (e.g., by performing an action before a predetermined expiration time), the content server 302 can continue to sequentially provide content items in the first sequence 314 to the user. For example, the user may interact with the presented content item 368 within a short time (e.g., within one minute) after the presented content item 368 is displayed on the user device 354 (e.g., as illustrated by an interaction indication 370 provided to the content server 302). The interaction with the presented content item 368 can keep the user “in sequence”, and the user can become eligible to receive the next content item in the first sequence (e.g., the content item 320).

In some implementations, as well as incorporating an expiration time for determining when a user is in sequence, the content server 302 can determine to wait at least a predetermined wait time before providing a next content item in a sequence (e.g., after providing the current content item in the sequence). Both wait time(s) and expiration time(s) can be configured for a sequence to meet a goal of having a user make regular, repeated visits to a site, service, or application. Wait time(s) can be used, for example, to inhibit multiple or all content items in a sequence to be presented to the user in too short of a period of time (such timing (e.g., reminders) may be more than what is needed or desired by a content sponsor).

A wait time can be the same for all content items in the sequence or can be of a custom length for each content item in the sequence. Suppose, for example, that the wait time for content items in the first sequence 314 is twenty four hours. The content server 302 can, for example, determine to not select the content item 320 in response to received requests for content for the user device 354 for a period of twenty four hours from the providing of the presented content item 368 (e.g., twenty four hours from 5/7/14 6 pm, or 5/8/14 6 pm). When a request for content from the user device 354 is received after the wait period ends and before an expiration time, the content server 302 can select the content item 320 in response to a request for content from the user device 354. The expiration time can be, for example, twenty four hours after the wait period ends.

For example, the content server 302 can receive a sixth content request 372 for a content slot 374 presented on a resource 376. The sixth content request 372 can be received at a time (e.g., 5/9/14 2 pm) that is after the wait period and before an expiration time. The content server 302 can determine to select the next item in the first sequence 314 (e.g., the content item 320). The content server 302 can provide the content item 320 to the user device 354 (e.g., as illustrated by a provided content item 378), for presentation in the content slot 374 (e.g., as illustrated by a presented content item 380).

As described above, the first sequence 314 can be configured to meet a goal of having a user make regular, repeated visits to the examplemerchant.com site. Accordingly, the content sponsor can associate a reward with some or all of the content items included in the first sequence 314. For example, each of the content items 318, 319, and 320 can present a discount offer for the example merchant site. In some implementations, such rewards or discounts can become progressively more attractive to a user the longer the user remains in sequence. For example, the content items 318, 319, and 320 present progressively larger discounts of 5, 10, and 15 percent off, respectively. In some implementations, an offered reward can be reduced or removed for a user when a user does not engage with the content sequence.

Once the user has been presented the last item in a sequence (e.g., the user of the user device 354 has been presented the content item 320), the content server 302 can make various determinations as far as considering content items in the sequence or other sequences for future requests for content. For example, when the user continues to engage with the example merchant site on a regular basis, the content server 302 can determine that the last item in the first sequence 314 (e.g., the content item 320) is eligible for content requests. As another example, the content server 302 can determine that the content item 320 is not eligible for future requests for content until the user “goes through” the first sequence 314 again. For example, the content item 318 may again become eligible for content requests after the content item 320 has been presented to the user. In some implementations, after the content item 320 has been presented to the user, the content item 318 is eligible for content requests after a predetermined wait time, where the wait time may be different (e.g., longer) than the wait time(s) between presentations of content items within the first sequence 314. For example, the wait time for presentation of content items within the first sequence 314 may be one day and a wait time to restart the entire first sequence 314 may be one week.

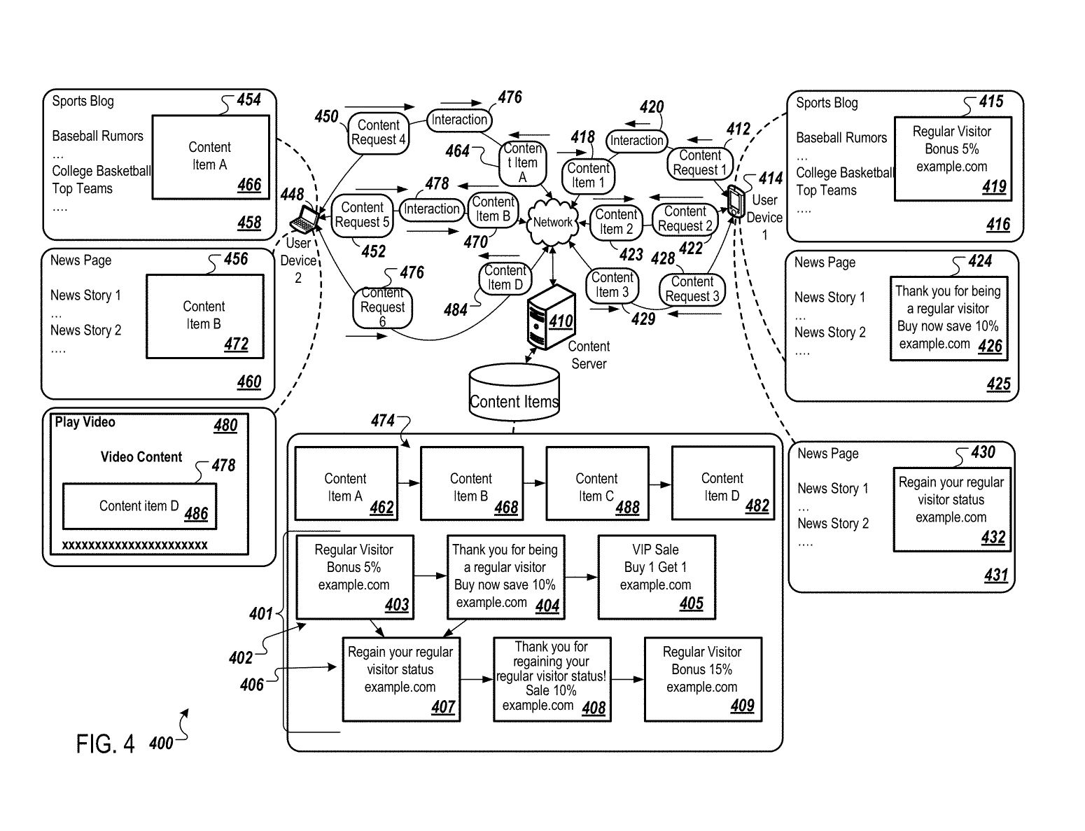

FIG. 4 is a block diagram of an example system 400 for providing content to a user. In some implementations, a content sequence can include one or more branches. For example, a content sequence 401 associated with a content sponsor includes a main sequence 402 that includes content items 403, 404, and 405, and a branch sequence 406 that includes content items 407, 408, and 409. The providing of content items from the content sequence 401 can include branching from the main sequence 402 to the branch sequence 406 when, for example, a condition is met (e.g., a user fails to engage with a content item) in the main sequence 402.

For example, a content server 410 can receive a first content request 412 from a user device 414 for a content slot 415 included in a resource 416. The content server 410 can select the content item 403 in response to the first content request 412 and can provide the content item 403 to the user device 414 (e.g., as illustrated by a provided content item 418), for presentation in the content slot 415 (e.g., as illustrated by a presented content item 419).

Suppose that the user of the user device 414 interacts with (e.g., selects) the presented content item 419. The content server 410 can receive an indication 420 of the interaction. In response to receiving the indication 420, the content server 410 can provide the content item 404 to the user device 414 in response to a second content request 422, as illustrated by a provided content item 423, for presentation in a content slot 424 associated with the second content request 422 and included in a resource 425 (e.g., as illustrated by a presented content item 426).

Suppose also that the user of the user device 414 does not interact with the presented content item 426. The user of the user device 414 may, for example, also not (e.g., in a predetermined time period after the presentation of the content item 426) interact with other presented content items associated with the content sponsor, or otherwise engage with or visit a site, service, application or other resource associated with the content sponsor. In response to the user not engaging with the presented content item 426 (and/or in response to the user generally not engaging with the content sponsor), the content server 410 can determine that the user of the user device 414 is “out of sequence” with regards to the main sequence 402. Rather than restart the main sequence 402 for the user, the content server 410 can associate the user with the branch sequence 406.

For example, the content server 410 can select the content item 407 in response to a subsequent content request, such as a third content request 428. The content item 407 can be provided to the user device 414 (e.g., as illustrated by a provided content item 429), for presentation in a content slot 430 associated with the third content request 428 and included in a resource 431 (e.g., as illustrated by a presented content item 432). The content server 410 can select next content item(s) in the branch sequence 406 (e.g., the content item 408, the content item 409), in response to subsequent requests for content associated with the user of the user device 414, as long as the user of the user device 414 continues to engage with presented content items (and/or generally engages with the content sponsor).

Various types of branching can occur in a content sequence. For example, both the content item 403 and the content item 404 of the main sequence 402 are linked to the sequence branch 406. For example, such linking can indicate that when a user who has been presented either the content item 403 or the content item 404 fails to engage with a respective presented content item (and/or fails to otherwise engage with the content sponsor), that the content server 410 can associate the user with the branch sequence 406 for subsequent requests for content, at least during an upcoming time period. As another example of branching, a main sequence can branch to multiple branch sequences (e.g., sub sequences). Other types of branching can be supported.

The content sequence 401, including the main sequence 402 and the branch sequence 406, can be designed to encourage users to be repeat visitors of the site associated with the content sponsor. For example, the content item 403, which includes a regular visitor bonus of 5%, can be presented to the user after the user has engaged with the content sponsor. When the user engages again, the content item 404 can be presented, which includes a message that thanks the user for being a regular visitor and includes a discount offer of 10%. When the user engages once again, the content item 405 can be presented, which includes a “VIP” (Very Important Person) message which includes a buy one get one free offer. When the user does not engage (e.g., within a predetermined time period) after being presented the content item 403 or the content item 404, the content item 407 (e.g., the first item in the branch sequence 406) can be presented, which includes a message which encourages the user to regain a regular visitor status. When the user engages after being presented the content item 407, the content item 408 can be presented, which includes a message thanking the user for regaining their regular visitor status and offering a 10% discount. When the user engages after being presented the content item 408, the content item 409 can be presented, which includes a discount offer of 15% for regular visitors. The discounts and promotions described are merely examples of possible promotions or awards that can be used with these systems.

In some implementations, the content server 410 can advance a user by more than one content item in a sequence. For example, the user may have engaged more than a threshold amount (e.g., within a predetermined time period) or may have performed one or more actions that indicate that the user is a highly-engaged user. The content server 410 can advance the user, for example, to a last item in a content sequence or to some other content item in the content sequence that is more than one item ahead of the user's current position in the content sequence. Similarly, a user can be “progressed” back in a sequence one or multiple steps (without necessarily restarting the sequence) depending on user interaction.

For example, the content server 410 may have received, from a user device 448, a fourth request for content 450 and a fifth request for content 452, for content slots 454 and 456, included in resources 458 and 460, respectively. The content server 410 may have provided a content item 462 in response to the fourth content request 450 (e.g., as illustrated by a provided content item 464), for presentation in the content slot 454 (e.g., as illustrated by a presented content item 466) and may have provided a content item 468 in response to the fifth content request 452 (e.g., as illustrated by a provided content item 470), for presentation in the content slot 456 (e.g., as illustrated by a presented content item 472), where the content items 462 and 468 are included in a content sequence 474.

The content server 410 can receive an indication 476 of one or more interactions with the presented content item 466 and an indication 478 of one or more interactions with the presented content item 472. The content server 410 can receive other indications of other interactions by the user of the user device 448 with other content associated with the content sponsor. Some or all of the received interactions can indicate that the user of the user device 448 has engaged with the content sponsor by more than a threshold amount and/or that the user has performed one or more actions that result in the user being classified as a highly-engaged user. For example, the received interactions can indicate that the user has performed one or more conversions (e.g., purchases). As another example, the received interactions may indicate that the user has spent more than a threshold amount of time using resource(s) associated with the content sponsor. As yet another example, the received interactions may indicate that the user has visited more than a threshold number of resources (e.g., web pages) associated with the content sponsor or has navigated to at least a certain level of a resource (e.g., web site) associated with the content sponsor.

In response to determining that the user has engaged with the content sponsor by more than a threshold amount and/or that the user has been classified as a highly-engaged user, the content server 410 can determine to advance the user in the content sequence 474 by more than a single sequence step (e.g., single content item advancement). For example, in response to a subsequent content request, such as a sixth content request 476 for a content slot 478 included in a resource 480, the content server 410 can select a last content item 482 in the content sequence 474. The content item 482 can be provided to the user device 448 (e.g., as illustrated by a provided content item 484), for presentation in the content slot 478 (e.g., as illustrated by a presented content item 486). The selection of the content item 482 in this example results in the skipping of a second-to-last content item 488 in the content sequence 474.

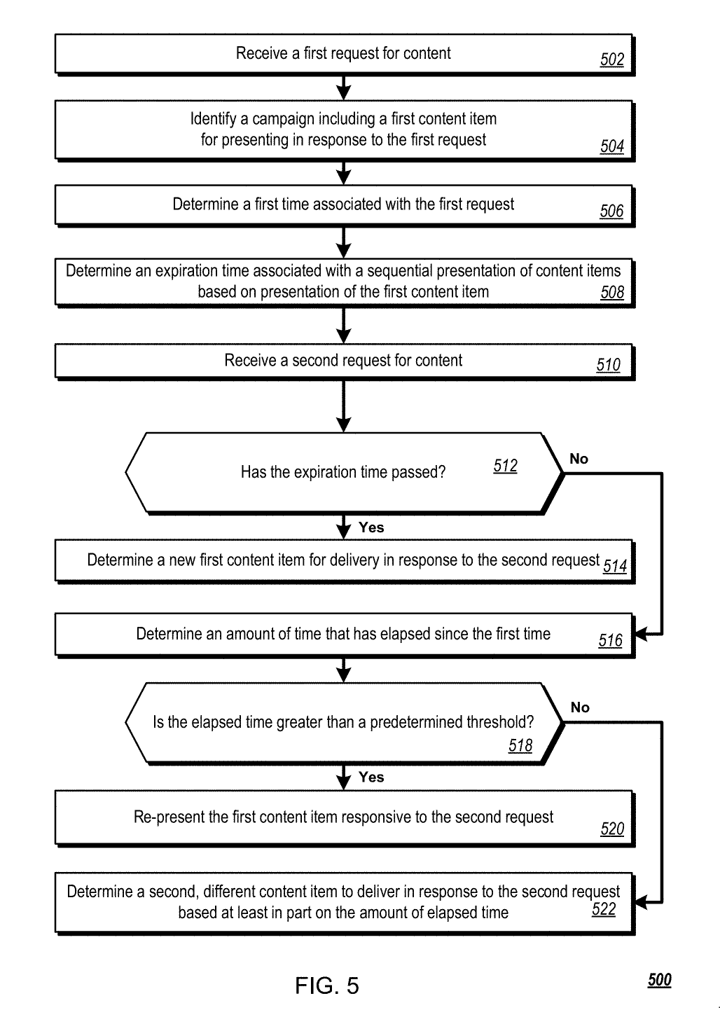

FIG. 5 is a flowchart of an example process 500 for sequential presentation of content. The process 500 can be performed, for example, by the content management system 110 described above with respect to FIG. 1, the content server 302 described above with respect to FIG. 3, or the content server 410 described above with respect to FIG. 4.

A first request for content is received (502). The first request can be received, for example, from a user device. The first request can be, for example, a request for content to present in a first content slot. The first content slot can be included, for example, in a first resource.

A campaign including a first content item for presenting in response to the first request is identified (504). The campaign can be, for example, an advertising campaign or some other type of campaign associated with a content sponsor. The first content item can be, for example, an advertisement or some other type of content. In some implementations, the first content item is a brand content item. In some implementations, the first content item is an interactive content item with which a user can interact. The first content item can be, for example, included in a defined sequence of content items in the campaign. The first content item can be or can be associated with an application associated with the content sponsor.

A first time associated with the first request is determined (506). For example, the first time can be determined from information included with the first request. As another example, the first time can be determined by evaluating a log of content item requests. As yet another example, the first time can be determined when processing the first request.

An expiration time associated with a sequential presentation of content items is determined based on presentation of the first content item (508). For example, the expiration time can be determined by querying an expiration time campaign setting associated with the first content item and with a sequence of content items in which the first content item is included. The expiration time campaign setting can indicate, for example, a duration value (e.g., twenty four hours). The expiration time can be determined, for example, by adding the duration value to the first time (e.g., the expiration time may be twenty four hours after the first request for content).

In some implementations, the expiration time is adjusted based on a geographic location or other parameter associated with the first request for content. For example, the expiration time can be the next midnight in a time zone associated with the geographic location of the first request for content. In some implementations, when the first content item is an application, the expiration time can be based on loading the application. In some implementations, the expiration time is logged. For example, the expiration time can be logged in association with the first request for content and the campaign. In some implementations, a user device identifier associated with the user device is logged with the expiration time.

A second request for content is received (510). The second request can be received, for example, from the user device. The second request can be, for example, a request for content to present in a second content slot. The second content slot can be included, for example, in a second resource.

After receiving the second request for content, a determination is made as to whether the expiration time has passed (512). For example, the current time can be compared to the expiration time.

When the expiration time has passed, a new first content item for delivery in response to the second request is determined (514). For example, the first content item can be re-delivered in response to the second request. As another example, the new first content item can be a different content item than the first content item. For example, the new first content item can be a content item that is not included in the sequence of content items that includes the first content item. For example, the new first content item can be included in a different sequence in the campaign or a different sequence in another campaign. As another example, the new first content item can be included in the campaign without being included in a sequence associated with the campaign.

When the expiration time has not passed, an amount of time that has elapsed since the first time is determined (516). For example, the amount of time can be determined by subtracting the first time from the current time.

In some implementations, a determination is made as to whether the elapsed time is greater than a predetermined threshold (518). When the elapsed time is greater than the predetermined threshold, the first content item can be re-presented responsive to the second request (520). For example, the sequence in which the first content item is included can be restarted.

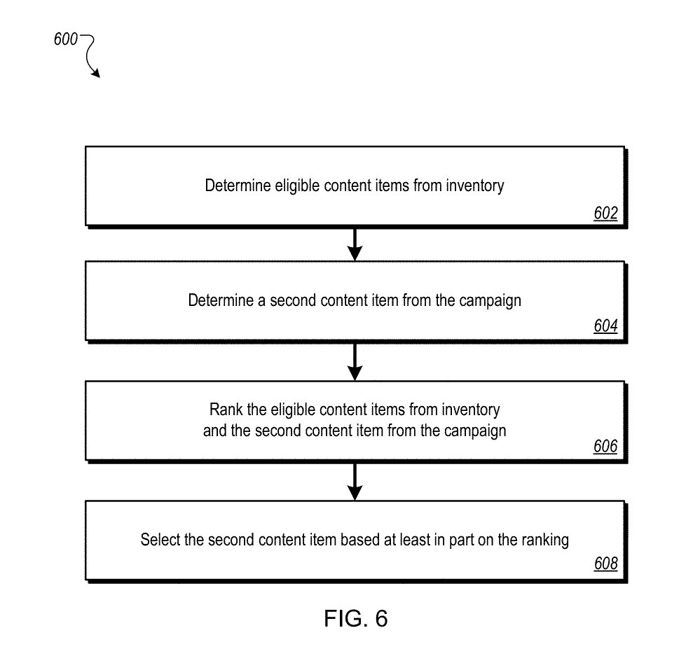

A second, different content item to deliver in response to the second request is determined based at least in part on the amount of elapsed time (522). In some implementations, the second, different content item to deliver in response to the second request is determined in response to determining that the elapsed time is not greater than the predetermined threshold. The second, different content item can be determined, for example, as described below with respect to FIG. 6.

FIG. 6 is a flowchart of an example process 600 for determining a second content item to deliver in response to a second request for content. The second request for content can be received after a first request for content in response to which a first content item from a campaign was provided. The process 600 can be performed, for example, by the content management system 110 described above with respect to FIG. 1, the content server 302 described above with respect to FIG. 3, or the content server 410 described above with respect to FIG. 4.

Eligible content items are determined from inventory (602). For example, content items that have an associated relevance score that is above a threshold can be determined to be eligible content items. A relevance score can indicate, for example, a match between a respective content item and the second request for content.

A second content item from the campaign is determined (604). The second content item can be a second, different content item (e.g., different than the first content item). The second content item can be, for example, a second content item in a sequence in the campaign (e.g., the first content item can be the first content item in the sequence).

The eligible content items from inventory and the second content item from the campaign are ranked (606). A score for the second content item can be boosted based at least in part on an amount of time since the first content item was presented.

The second content item is selected based at least in part on the ranking (608). For example, the second content item can be selected when the second content item has a highest rank among the ranked content items.

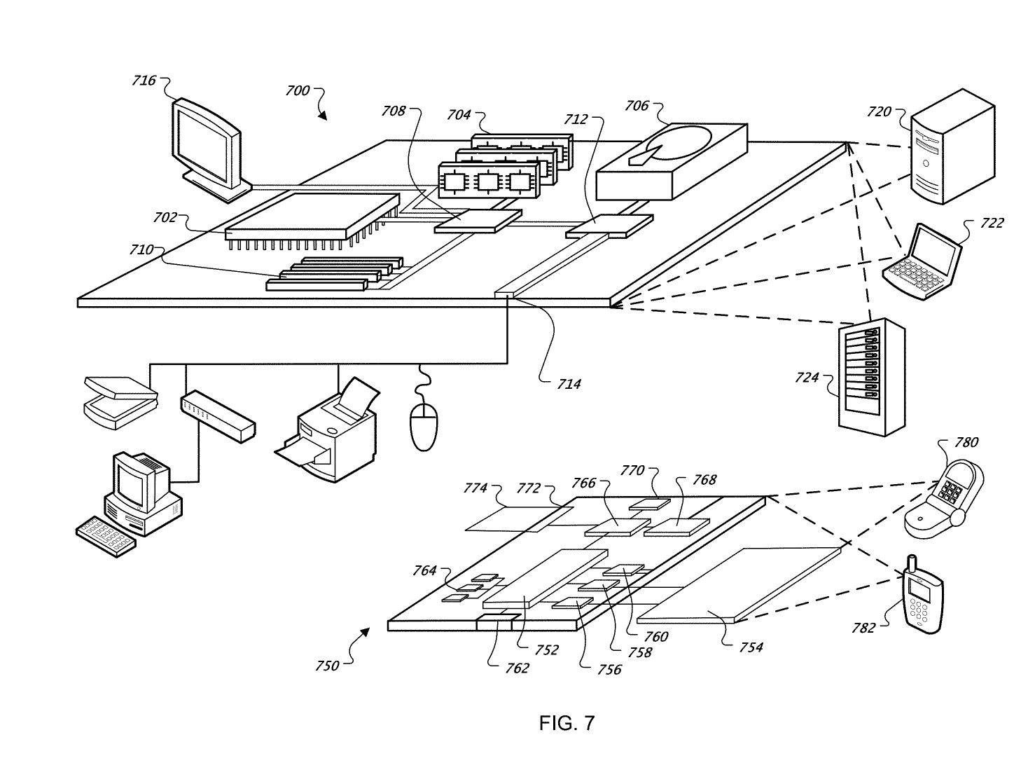

FIG. 7 is a block diagram of computing devices 700, 750 that may be used to implement the systems and methods described in this document, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be illustrative only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a computer-readable medium. The computer-readable medium is not a propagating signal. In one implementation, the memory 704 is a volatile memory unit or units. In another implementation, the memory 704 is a non-volatile memory unit or units.

The storage device 706 is capable of providing mass storage for the computing device 700. In one implementation, the storage device 706 is a computer-readable medium. In various different implementations, the storage device 706 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of duties is illustrative only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can process instructions for execution within the computing device 750, including instructions stored in the memory 764. The processor may also include separate analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD display or an OLED display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication (e.g., via a docking procedure) or for wireless communication (e.g., via Bluetooth or other such technologies).

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 may also be provided and connected to device 750 through expansion interface 772, which may include, for example, a SIMM card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS receiver module 770 may provide additional wireless data to device 750, which may be used as appropriate by applications running on device 750.

Device 750 may also communication audibly using audio codec 760, which may receive spoken information from a user and convert it to usable digital information. Audio codex 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A method comprising:
receiving a first request for content from a given user visiting a first resource;
identifying a campaign that includes a sequence of content items and specifies an order in which the sequence of content items are to be delivered to a same user;
determining a first time of the first request;
delivering a first content item from the sequence of content items to the given user in response to the first request;
determining an expiration time that specifies how long after the first time a second content item from the sequence of content items remains eligible for delivery to a subsequent request for content received from the given user;
determining, by one or more computers, a wait time that specifies how much time must elapse between delivery of the first content item from the sequence and delivery of the second content item, wherein the wait time is less than the expiration time;
receiving, by the one or more computers, a second request for content from the given user visiting a different resource at a second time that is after the first time when the given user visited the first resource;
after receiving the second request for content, determining, by the one or more computers, whether the expiration time has passed based on an amount of time that has elapsed between the first time and the second time; and
responding, by the one or more computers, to the second request, including:
delivering, in response to the second request, the second content item from the sequence of content items to the given user when the wait time has passed and the expiration time has not passed at the second time of the second request for content from the given user visiting the different resource; and
delivering, in response to the second request, a different content item when either of the expiration time has passed or the wait time has not passed at the second time of the second request for content from the given user visiting the different resource.

2. (canceled)

3. The method of claim 1 wherein delivering the second content item is conditioned on performance of a specified action by the given user after delivering the first content item to the given user and before receiving the second request.

4. The method of claim 1 wherein when the determined elapsed time is greater than a predetermined threshold, re-presenting the first content item responsive to the second request.

5. (canceled)

6. The method of claim 1, further comprising selecting the second content item, including determining eligible content items from inventory, ranking the eligible content items from inventory and the second content item, and selecting the second content item based at least in part on the ranking.

7. The method of claim 6 wherein a score for the second content item is boosted based at least in part on an amount of time since the first content item was presented.

8. The method of claim 1, further comprising adding a countdown timer to the first content item to show an amount of time until the expiration time.

9. The method of claim 1 further comprising providing a reward for generating the second request prior to the occurrence of the expiration time.

10. The method of claim 1 further comprising determining the expiration time based at least in part on input from a content sponsor associated with the campaign.

11. The method of claim 1 wherein the expiration time is adjusted based on a geographic location of the first or second request.

12. The method of claim 1 wherein the expiration time depends on a platform on which the first content item was served or a platform on which the second request occurred.

13. The method of claim 1 wherein the first content item is an application and the expiration time is based on loading the application.

14. A non-transitory computer program product tangibly embodied in a computer-readable storage device and comprising instructions that, when executed by one or more processors, cause the one or more processors to:
receive a first request for content from a given user visiting a first resource;
identify a campaign that includes a sequence of content items and specifies an order in which the sequence of content items are to be delivered to a same user;
determine a first time of the first request;
deliver a first content item from the sequence of content items to the given user in response to the first request;
determine an expiration time that specifies how long after the first time a second content item from the sequence of content items remains eligible for delivery to a subsequent request for content received from the given user;
determine a wait time that specifies how much time must elapse between delivery of the first content item from the sequence and delivery of the second content item, wherein the wait time is less than the expiration time;
receive a second request for content from the given user visiting a different resource at a second time that is after the first time when the given user visited the first resource;
after receiving the second request for content, determine whether the expiration time has passed based on an amount of time that has elapsed between the first time and the second time; and
respond to the second request, including:
delivering, in response to the second request, the second content item from the sequence of content items to the given user when the wait time has passed and the expiration time has not passed at the second time of the second request for content from the given user visiting the different resource; and
delivering, in response the second request, a different content item when either of the expiration time has passed or the wait time has not passed at the second time of the second request for content from the given user visiting the different resource.

15. (canceled)

16. The product of claim 14 wherein when the determined elapsed time is greater than a predetermined threshold, re-presenting the first content item responsive to the second request.

17. (canceled)

18. A system comprising:
one or more processors; and
one or more memory elements including instructions that when executed cause the one or more processors to:
receive a first request for content from a given user visiting a first resource;
identify a campaign that includes a sequence of content items and specifies an order in which the sequence of content items are to be delivered to a same user;
determine a first time of the first request;
deliver a first content item from the sequence of content items to the given user in response to the first request;
determine an expiration time that specifies how long after the first time a second content item from the sequence of content items remains eligible for delivery to a subsequent request for content received from the given user;
determine a wait time that specifies how much time must elapse between delivery of the first content item from the sequence and delivery of the second content item, wherein the wait time is less than the expiration time;
receive a second request for content from the given user visiting a different resource at a second time that is after the first time when the given user visited the first resource;
after receiving the second request for content, determine whether the expiration time has passed based on an amount of time that has elapsed between the first time and the second time; and
respond to the second request, including:
delivering, in response to the second request, the second content item from the sequence of content items to the given user when the wait time has passed and the expiration time has not passed at the second time of the second request for content from the given user visiting the different resource; and
delivering, in response to the second request, a different content item when either of the expiration time has passed or the wait time has not passed at the second time of the second request for content from the given user visiting the different resource.

19. (canceled)

20. The system of claim 18 wherein when the determined elapsed time is greater than a predetermined threshold, re-presenting the first content item responsive to the second request.
